(19) United States
(12) Patent Application Publication
(10) Pub. No.: US 2023/0172778 A1
(43) Pub. Date: Jun. 8, 2023

(54) TRACKED MOBILITY DEVICE

(71) Applicant: Trackmaster, LLC, Clearwater, FL (US)

(72) Inventor: Travis Underwood, Clearwater, FL (US)

(21) Appl. No.: 18/046,245

(22) Filed: Oct. 13, 2022

Related U.S. Application Data
(60) Provisional application No. 63/262,508, filed on Oct. 14, 2021.

(51) Int. Cl. A61G 5/04; A61G 5/06

(52) U.S. Cl. CPC A61G 5/041; A61G 5/063; A61G 5/1089

(57) ABSTRACT

A chassis for a tracked mobility device may include: a battery box floor; a battery box rear wall; a pair of main side rails; a main front cross member; a lower box rear cross member; a pair of side bogie support tubes; a pair of motor support tubes; rear side support tubes; front side support tubes; a pair of bogie support plates; short bogie cross tubes; seat frame plates; a tensioner support frame; a rear cross support plate; motor/gear boxes having floors, rear walls, outer side walls, inner side walls, and outer side wall extensions/gussets; anti-tip tubes; anti-tip cross-members; and anti-tip vertical tie rods. The chassis components may be welded together to provide a rigid, stable, unitary construction.

### REFERENCE TO RELATED APPLICATIONS

This application claims the benefit of U.S. Provisional Application No. 63/262,508, filed, Oct. 14, 2021, the entire contents of which is hereby incorporated herein by reference.

### FIELD OF THE INVENTION

The present invention relates generally to devices for transporting an individual, and more particularly to a personally mobility device that is powered by a track or pair of tracks.

### BACKGROUND

Military veterans are increasingly returning from assignment overseas with injuries that compromise their ability to participate in outdoor activities such as hunting and fishing. While personal mobility devices with room for one user and a small amount of cargo are known, those devices typically do not allow the mobility and stability that is needed by veterans who desire to be active in spite of injuries to their legs. For example, prior art wheeled mobility devices cannot traverse rough or uneven terrain, and prior art tracked mobility devices typically contact the ground with a long and wide footprint that is too big for use indoors. Tracked mobility devices may also require significant power to overcome the resistance of friction during movement, and can cause significant damage to carpets or floors when used indoors. Further, the turning radius of a tracked vehicle is typically larger than the turning radius of a wheeled vehicle due to the length of the track.

Applicant's U.S. Pat. No. 8,371,403 sought to address problems associated with prior art mobility vehicles by providing improvements to tracked mobility devices. Similarly, applicant's U.S. Pat. No. 8,783,392 discloses other improvements to tracked mobility devices. In spite of those improvements though, a need continues to exist for improvements to personal mobility vehicle that will improve the low-friction, quick-turning, indoor and outdoor drivability of the device while still providing the superior off-road capability of a tracked vehicle. The present invention addresses that need.

### SUMMARY OF THE INVENTION

One aspect of the present invention provides a chassis for a tracked mobility device. The chassis may include:
a battery box floor (101);
a battery box rear wall (102);
a pair of main side rails (103);
a main front cross member (104);
a lower box rear cross member (105);
a pair of side bogie support tubes (106);
a pair of motor support tubes (107)
side support tubes, rear (108)
side support tubes, front (109);
a pair of bogie support plates (110);
short bogie cross tubes (111);
seat frame plates (114);
a tensioner support frame (115);
a rear cross support plate (117);
motor/gear boxes (120);
a motor/gear box floors (121);
a motor/gear box rear walls (122);
a motor/gear box outer side walls (124);
a motor/gear box inner side walls (125);
motor/gear box outer side wall extensions/gussets (126);
anti-tip tubes (130);
anti-tip cross-members (131); and
anti-tip vertical tie rods (132);

wherein the chassis components are welded together to provide a rigid, stable, unitary construction.

Another aspect of the present invention provides a lower unit for a tracked mobility device. The lower unit may include:
a) the chassis components of claim 1;
b) a pair of track drives;
wherein each track drive comprises:
   i) a drive wheel (211);
   ii) a rear ground contacting bogie wheel assembly (212);
   iii) a front ground contacting bogie wheel assembly (213);
   iv) a tensioner bogie wheel assembly (214);
   v) an idler wheel assembly (215); and
   vi) a flexible track;
c) a pair of motors and associated gears, with each motor/gear assembly being operably connected to one of the track drives;
d) one or more batteries operably connected to the pair of motors; and
e) a pair of rear anti-tip wheels; and
f) a vibration-reducing and dampening assembly mounted to the chassis and adapted to receive a seat assembly.

In another aspect the vibration-reducing and dampening assembly may comprises:
i) an upper cop mounted to the lower unit,
ii) a lower cup mountable to a seat; and
iii) an elastomeric gromet disposed between the upper and lower cups and effective to allow the upper and lower cups to move with respect to each other in a manner effective to substantially reduce and dampen vibration between the lower unit and a seat attached thereto.

Another aspect of the present invention provides a tracked mobility device. The tracked mobility device may include:
a) a lower unit as previously described;
b) a seat, mounted to the vibration-reducing and dampening assembly;
c) one or more arm rests;
d) a control unit to control the speed and direction of movement of the device; and
e) an optional foot rest.

Another aspect of the present invention may comprise an ornamental design for a chassis for a tracked mobility device, as shown in FIGS. 1-22.

### DESCRIPTION OF THE DRAWINGS

FIGS. 1-15 show a chassis for a tracked mobility device, according to one preferred embodiment.

FIGS. 16-20 show a lower unit for a tracked mobility device, or parts therefor, according to certain preferred embodiments.

FIGS. 21-22 show a tracked mobility device, according to certain preferred embodiments.

### WRITTEN DESCRIPTION OF THE PREFERRED EMBODIMENTS

For the purposes of promoting an understanding of the principles of the invention, reference will now be made to certain embodiments and specific language will be used to describe the same. It will nevertheless be understood that no limitation of the scope of the invention is thereby intended, with such alterations and modifications to the illustrated device being contemplated as would normally occur to one skilled in the art to which the invention relates.

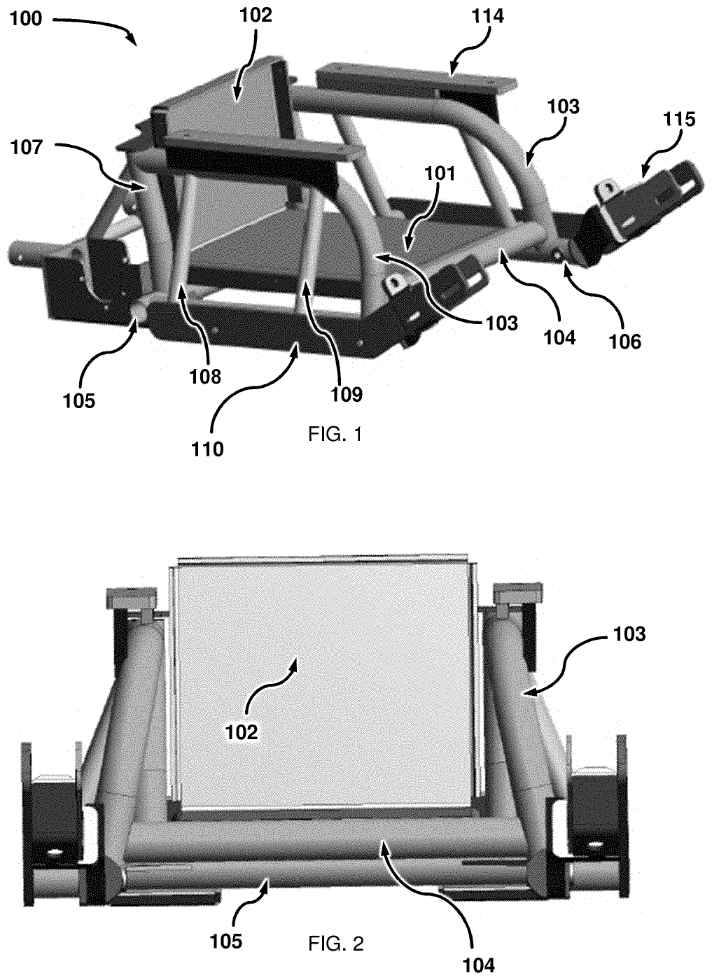

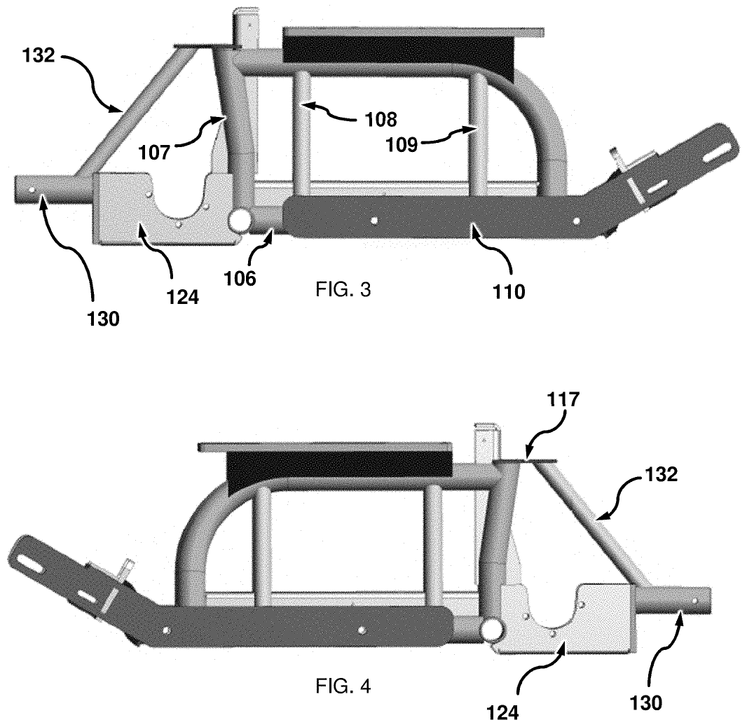

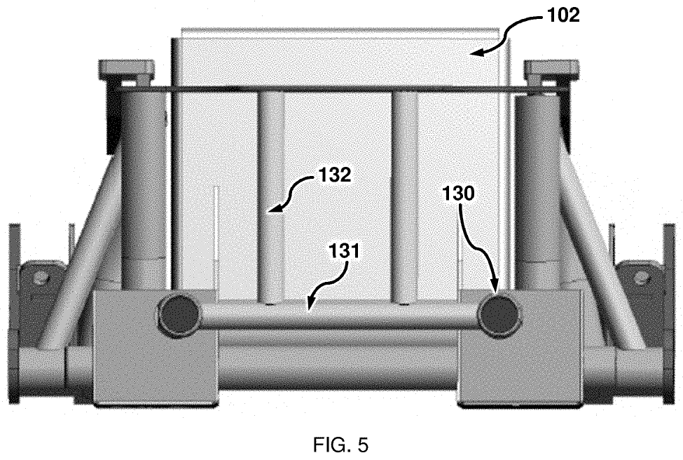

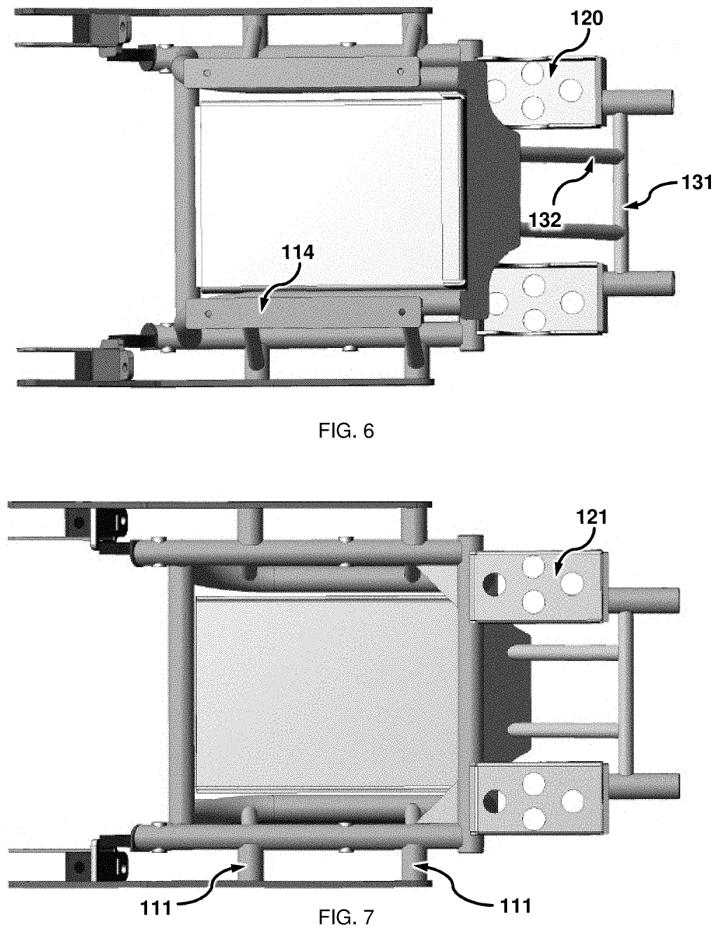

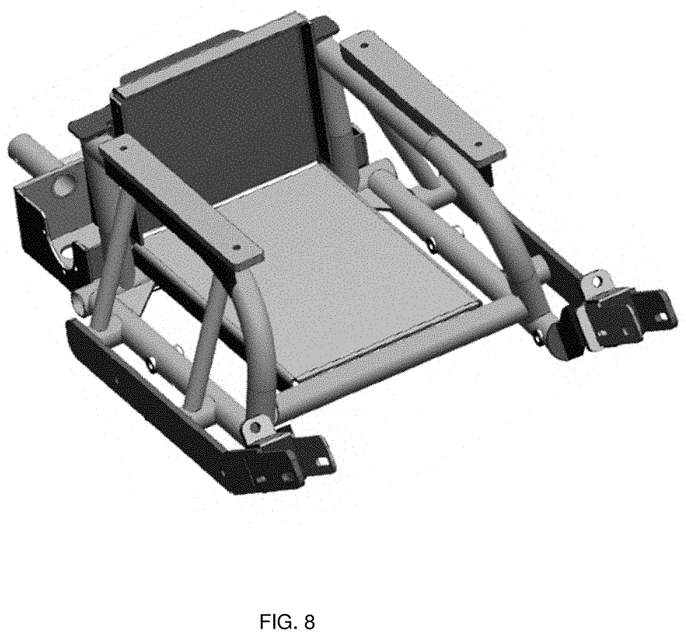

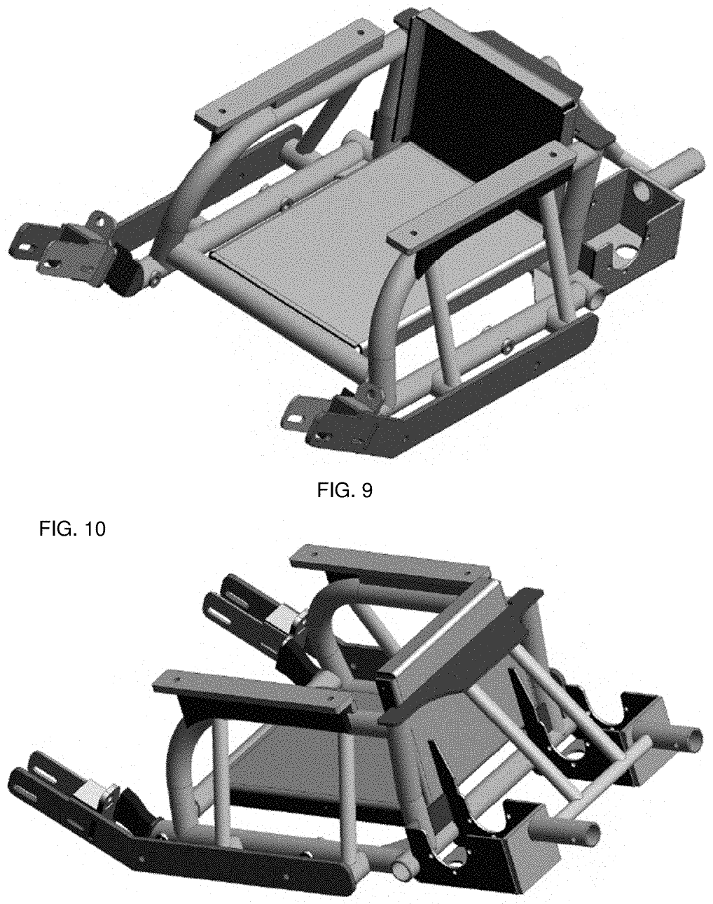

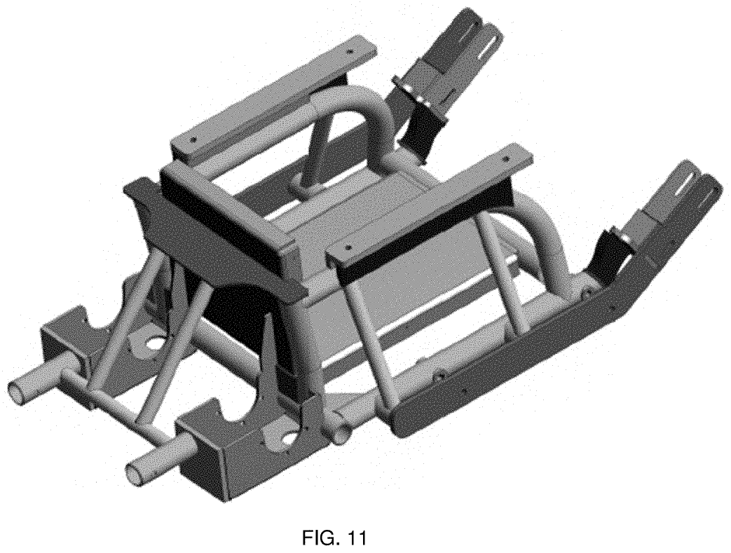

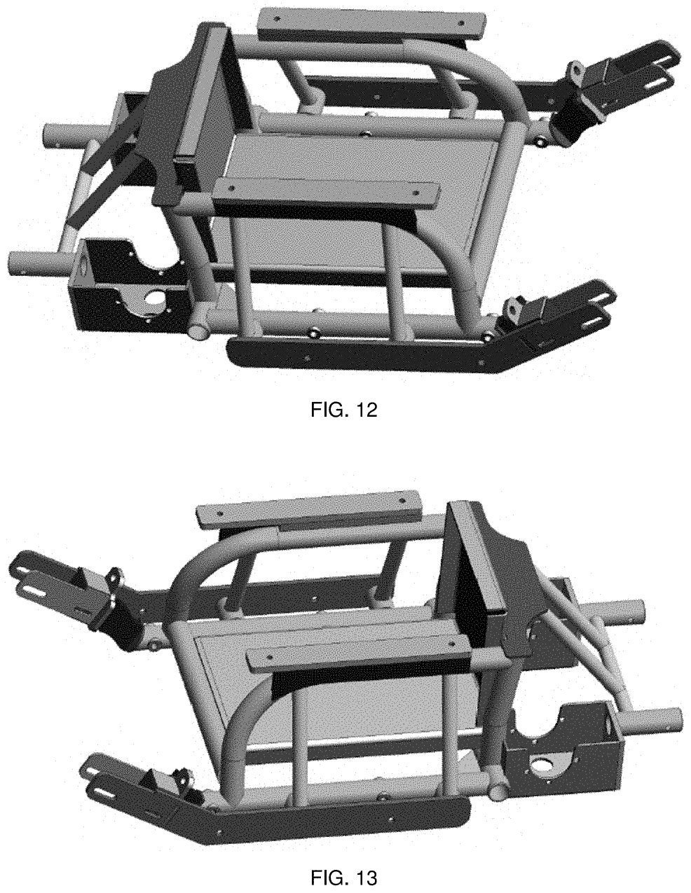

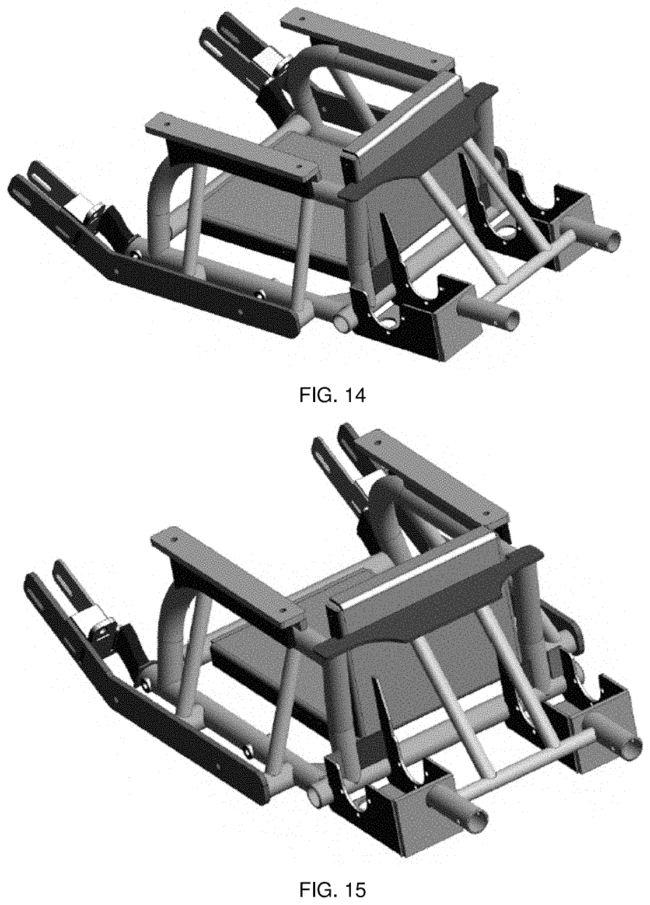

As previously indicated, one aspect of the present invention provides a chassis for a tracked mobility device, as shown in the accompanying FIGS. 1-15. The chassis preferably comprises:

a battery box floor (101);

a battery box rear wall (102);

a pair of main side rails (103);

a front main cross member (104);

a lower rear cross member (105);

a pair of side bogie support tubes (106);

a pair of motor support tubes (107)

side support tubes, rear (108)

side support tubes, front (109);

a pair of bogie support plates (110);

short bogie cross tubes (111);

seat frame plates (114);

a tensioner support frame (115);

a rear cross support plate (117);

motor/gear boxes (120);

a motor/gear box floors (121);

a motor/gear box rear walls (122);

a motor/gear box outer side walls (124);

a motor/gear box inner side walls (125);

motor/gear box outer side wall extensions/gussets (126);

anti-tip tubes (130);

an anti-tip cross-member (131); and

anti-tip vertical tie rods (132).

The chassis components are preferably welded together to provide a rigid, stable, unitary construction. For example, the motor/gear box outer side wall may include extensions/gussets (126) that extend upward and are welded to the back wall of the battery box. This ties the battery box and the motor boxes together, and, in combination with the lower rear cross member and the anti-tip tubes and associated cross members, provides a particularly stable and rigid frame. Similarly, the area in which the batteries reside (referred to generally as the battery box) is formed by welding the battery box floor, battery box rear wall, the pair of main side rails, the main front cross member, the lower rear cross member, the pair of side bogie support tubes, and the front and rear side support tubes together to form a solid construction that is tied to the other portions of the chassis.

More particularly, the “battery box” portion of the chassis is generally the area bounded by the battery box floor 101 on the bottom, and the battery box rear wall 102 in the back. Main side rails 103 extend along the sides from the front of the battery box floor to the upper portion of the battery box rear wall. Front and rear cross members 104 and 105, respectively, provide additional support in those sections, and side bogie tubes 106 support the lower sides. Motor support tubes 107 extend upward alone the sides of the rear wall.

Similarly, the bogie wheel frames are generally defined by the area adjacent the battery box floor along the sides, and further include side bogie support tubes 106 on the inside, and bogie support plates 110 on the outside. A pair of short bogie cross tubes connect the bogie support tube to the bogie support plate. A pair of side support tubes, 108 and 109, extend from the short bogie cross tubes to the upper/horizontal portion of each main side tube. A tensioner frame portion is provided at the front of the bogie wheel frame to support and provide the appropriate adjustment for the tensioner wheels.

The rear portion of the chassis is generally defined by the area including the two motor/gear boxes and the anti-tip assembly. Each motor/gear box includes a motor/gear box floor 121, a motor/gear box rear wall 122, a motor/gear box outer side wall 124, and a motor/gear box inner side wall 125. The motor/gear box inner side wall extends upward to provide motor/gear box outer side wall extensions/gussets 126 that tie to the rear wall of the battery box. Anti-tip tubes 130 extend outward from each motor/gear box, and are connected by an anti-tip cross-member 131. Anti-tip vertical tie rods 132 connect the anti-tip cross member to the rear cross support plate 117, although connection to the battery box rear wall may be made in addition or instead.

All of the main portions, namely, the battery box portion, the two side bogie wheel portions, and the rear motor/anti-tip portion, are welded together to form one unitary construction of superior strength and rigidity.

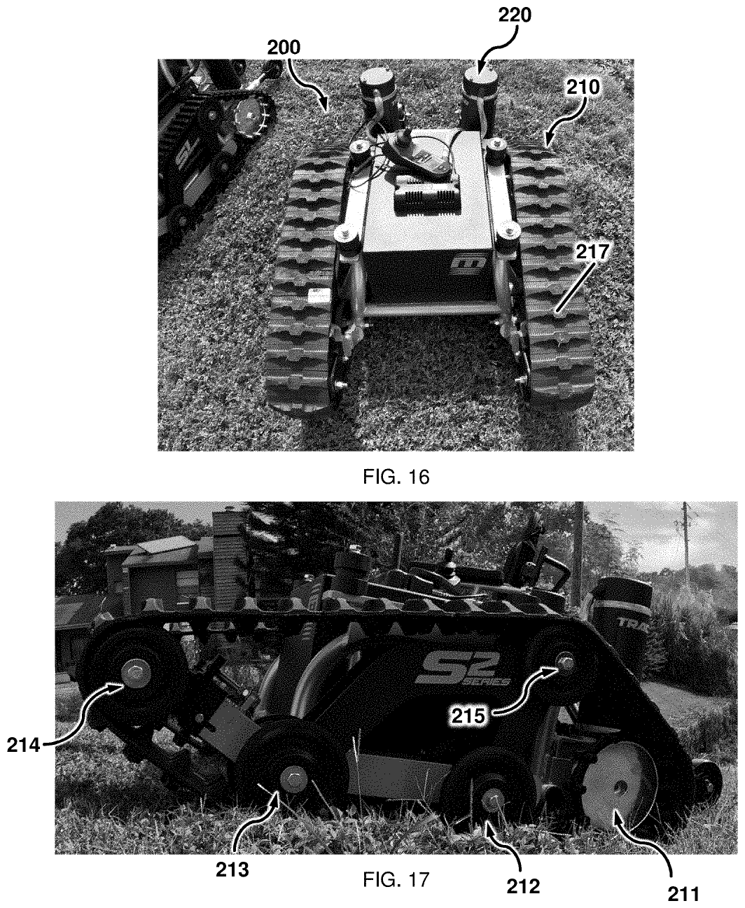

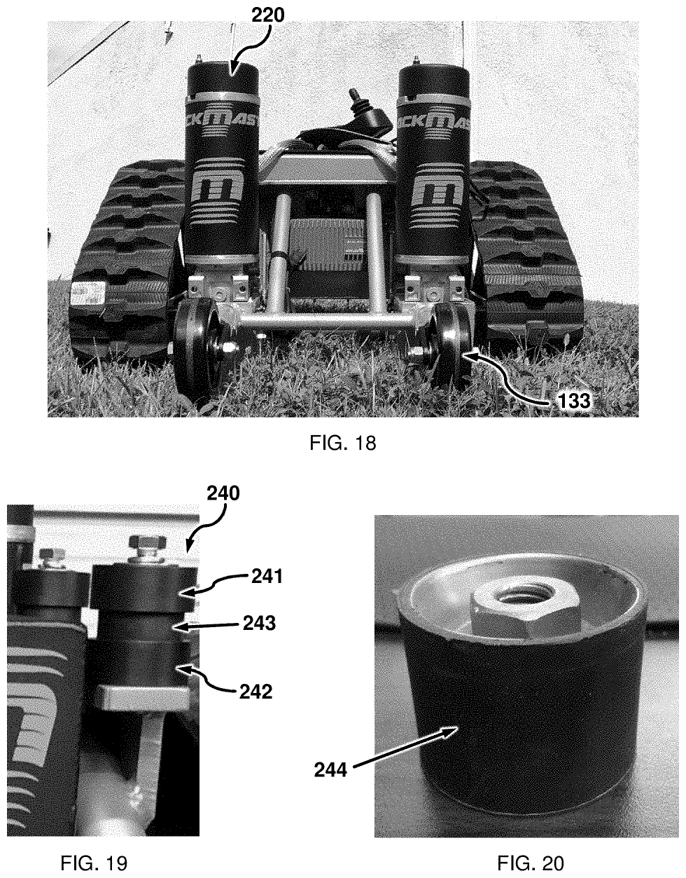

In a second aspect of the present invention, there is provided a lower unit for a tracked mobility device, as shown in the accompanying FIGS. 16-20. The lower unit preferably comprises:
a) a chassis, as described above;
b) a pair of track drives;
wherein each track drive comprises:
   i) a drive wheel (211);
   ii) a rear ground contacting bogie wheel assembly (212);
   iii) a front ground contacting bogie wheel assembly (213);
   iv) a tensioner bogie wheel assembly (214);
   v) an idler wheel assembly (215); and
   vi) a flexible track;
c) a pair of motors and associated gears, with each motor/gear assembly being operably connected to one of the track drives;
d) one or more batteries (preferably two batteries) operably connected to the pair of motors; and
e) a pair of rear anti-tip wheels; and
f) a vibration-reducing and dampening assembly mounted to the chassis and adapted to receive a seat assembly.

The lower unit preferably includes a pair of track drives, with each track drive comprising a flexible track running on a set of bogie wheels. In one embodiment the set of bogie wheels comprises a drive wheel 211, a pair of adjacent rearward ground contacting wheels 212, a pair of adjacent forward ground contacting wheels 213, a pair of adjacent tensioning wheels 214, and a pair of adjacent idler wheels 215. The two wheels in each pair of adjacent wheels are spaced apart a distance effective to support and drive the track.

In one embodiment the drive wheel includes a scalloped diameter effective to reduce the accumulation of debris around the wheel, thus reducing the amount of debris that accumulates between the wheel and the track.

In one preferred embodiment the vibration-reducing and dampening assembly comprises a set of four vibration-reducing and dampening assembly units, with each unit comprising:
i) an upper cop mounted to the lower unit,
ii) a lower cup mountable to a seat; and
iii) an elastomeric gromet disposed between the upper and lower cups and effective to allow the upper and lower cups to move with respect to each other in a manner effective to substantially reduce and dampen vibration between the lower unit and a seat attached thereto.

The preferred vibration-dampening grommets are made of aa soft rubber, such as 65 durometer rubber, and the assembly is effective to substantially reduce vibration when an adult driver is operating the vehicle.

The lower unit preferably includes a pair of motors and associated gears, with each motor/gear assembly being operably connected to one of the track drives. The motors and associated gears are effective to power the vehicle and an adult operator at speeds up to 20 mph on flat terrain.

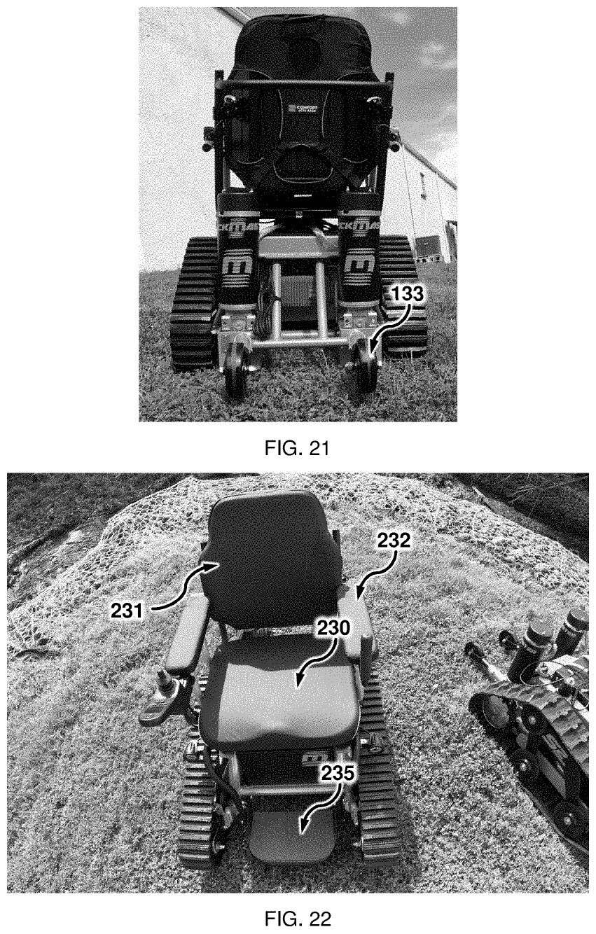

In a third aspect of the present invention, there is provided a tracked mobility device, as shown in FIGS. 21-22. The tracked mobility device preferably comprises:
a) a lower unit, as described above;
b) a seat, mounted to the vibration-reducing and dampening assembly;
c) one or more arm rests;
d) a control unit to control the speed and direction of movement of the device; and
e) an optional foot rest.

The assembled tracked mobility device is preferably sized to fit and operate in an ADA-compliant environment, and most preferably has a footprint that is no more than 29″ wide.

In a fourth aspect of the present invention, there is provided an ornamental design for a chassis for a tracked mobility device. FIGS. 1-22 show the ornamental design.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. In addition, it is to be appreciated that the present invention may comprise or consist essentially of any or all of the illustrated or described elements.

Additionally, it is top be appreciated that any or all of the features, elements, and/or embodiments disclosed herein may be combined with any or all of the other features, elements, and/or embodiments disclosed herein to provide a system or method that comprises or consists essentially of such features, elements, and/or embodiments.

The phrase A “and/or” B is used in this disclosure to mean A alone, or B alone, or both A and B.

1. A chassis (100) for a tracked mobility device comprising:
a battery box floor (101);
a battery box rear wall (102);
a pair of main side rails (103);
a main front cross member (104);
a lower box rear cross member (105);
a pair of side bogie support tubes (106);
a pair of motor support tubes (107)
side support tubes, rear (108)
side support tubes, front (109);
a pair of bogie support plates (110);
short bogie cross tubes (111);
seat frame plates (114);
a tensioner support frame (115);
a rear cross support plate (117);
motor/gear boxes (120);
a motor/gear box floors (121);
a motor/gear box rear walls (122);
a motor/gear box outer side walls (124);
a motor/gear box inner side walls (125);
motor/gear box outer side wall extensions/gussets (126);
anti-tip tubes (130);
anti-tip cross-members (131); and
anti-tip vertical tie rods (132);
wherein the chassis components are welded together to provide a rigid, stable, unitary construction.

2. A lower unit for a tracked mobility device, comprising:
a) the chassis components of claim 1;
b) a pair of track drives;
wherein each track drive comprises:
i) a drive wheel (211);
ii) a rear ground contacting bogie wheel assembly (212);
iii) a front ground contacting bogie wheel assembly (213);
iv) a tensioner bogie wheel assembly (214);
v) an idler wheel assembly (215); and
vi) a flexible track (217);
c) a pair of motors and associated gears, with each motor/gear assembly being operably connected to one of the track drives;
d) one or more batteries operably connected to the pair of motors; and
e) a pair of rear anti-tip wheels; and
f) a vibration-reducing and dampening assembly mounted to the chassis and adapted to receive a seat assembly.

3. A lower unit for a tracked mobility device according to claim 2, wherein the vibration-reducing and dampening assembly comprises:
i) an upper cop mounted to the lower unit,
ii) a lower cup mountable to a seat; and
iii) an elastomeric gromet disposed between the upper and lower cups and effective to allow the upper and lower cups to move with respect to each other in a manner effective to substantially reduce and dampen vibration between the lower unit and a seat attached thereto.

4. A tracked mobility device comprising:
a) a lower unit according to claim 2:
b) a seat, mounted to the vibration-reducing and dampening assembly;
c) one or more arm rests;
d) a control unit to control the speed and direction of movement of the device; and
e) an optional foot rest.
